(19) United States
(12) Patent Application Publication
(10) Pub. No.: US 2009/0148211 A1
(43) Pub. Date: Jun. 11, 2009

(54) IMAGE FORMING SYSTEM

(75) Inventor: Kazuyoshi KIMURA, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/326,562

(22) Filed: Dec. 2, 2008

(30) Foreign Application Priority Data
Dec. 5, 2007 (JP) 2007-314510

(51) Int. Cl. G03G 15/00

(52) U.S. Cl. 399/391

(57) ABSTRACT

An image forming system, including an image forming apparatus, and a first sheet supplying device which is connected to the image forming apparatus, wherein the first sheet supplying device includes a scanner, a plurality of drawer-type sheet supplying trays, and a control section which is configured to prevent a predetermined sheet supplying tray among the plurality of sheet supplying trays from being drawn out, based on an operational condition of the scanner.

### CROSS REFERENCE TO RELATED APPLICATION

This application is based on Japanese Patent Application No. 2007-314,510 filed on Dec. 5, 2007, in the Japanese Patent Office, the entire content of which is hereby incorporated by reference.

### TECHNICAL FIELD

The present invention relates to an image forming system in which an image forming apparatus and a sheet supplying device are connected to each other.

### BACKGROUND OF THE INVENTION

Image forming systems, each centered around the image forming apparatus employing an electro-photographic method, have become in heavy usage in fields of shortrun printing, outputting a great number of prints at high speed.

Said image forming apparatuses are mostly installed in common business offices, in which they are used to output printed matter, being mainly business letters.

Further, said image forming apparatuses are rarely used in a long continuous period.

However, since the image forming apparatuses, used in the field of shortrun printing, tend to output graduated sequential images, the consumption of toner per single copy sheet becomes excessive, and these image forming apparatuses, serving as production equipment, are used to increase their operation rates as much as possible.

Accordingly, the number of recording sheets and the amount of toner, to be used in a unit time in said field of shortrun printing, become incomparably greater than those of the image forming apparatuses used in common business offices.

As a result, the size of a toner cartridge, serving as a container to pack toner particles to be supplied to the image forming apparatus, can become extremely large, so that it is very difficult to position the toner cartridges optionally in an image developing device.

In order to overcome this shortcoming, an image forming apparatus has been provided which incorporates the toner cartridges relatively far away from and above the image developing device.

Further, a typical sheet supplying device tends to be combined in an image forming apparatus which conducts a great number of image forming processes at high speed, so that recording sheets are supplied to meet the processing capability of said image forming apparatus.

As a result, a scanner tends to be installed above the sheet supplying device connected to the image forming apparatus, though the scanner tends to have been installed above the image forming apparatus in the past.

In addition, the scanner described above is a common name of a well-known original document reading device, which scans to read the original document carrying printed images.

In the image forming system to conduct a great number of printing processes at high speed, recording sheets have to be frequently replenished onto the sheet supplying trays of the image forming apparatus, and also to the sheet supplying trays of the sheet supplying device connected to the image forming apparatus.

In the above described image forming system, incorporating the scanner on the sheet supplying device, vibration occurs when the sheets are supplied or the tray is inserted or drawn out, and the vibration likely reaches the scanner which is operating, resulting in adverse effects on the image reading operation.

In order to prevent such adverse effects due to the vibration occurred during the sheet supplying operation, Unexamined Japanese Patent Publication Application H5-77,938 discloses an image forming apparatus, in which the sheet supplying tray is prevented from being moved while the scanner is in operation. Further, Unexamined Japanese Patent Publication Application H5-155,445 discloses an image forming apparatus, in which the scanner operation is stopped, when the sheet supplying tray is moved.

However, in the above disclosed image forming apparatus and image forming system, when the scanner is in operation, recording sheets cannot be supplied, so that the image forming operation is often interrupted due to the stoppage of the sheet supplying operation.

Said interrupted operation results in a decreased operation rate of the image forming system, and in reduction of productivity of the print forming operation.

### SUMMARY OF THE INVENTION

The present invention has been made based on the above situation, wherein an object of the present invention is to provide an image forming system, which is characterized in that a sheet supplying operation to said sheet supplying device, adversely having vibration to reach the scanner, is prevented, and in that a sheet supplying operation, not transferring the vibration to the scanner, is allowed, in an image forming system including an image forming apparatus and a sheet supplying device, combined each other.

The above object is attained by realizing an invention described below.

An image forming system, including an image forming apparatus, and a first sheet supplying device connected to the image forming apparatus, wherein the first sheet supplying device includes a scanner, a plurality of drawer-type sheet supplying trays, and a control section which is configured to prevent a predetermined sheet supplying tray among the plurality of drawer-type sheet supplying trays from being drawn out, based on an operational condition of the scanner.

### BRIEF DESCRIPTION OF THE DRAWINGS

FIG. 1 is a schematic diagram of the image forming system.

FIG. 2 is a block diagram of a control system of the image forming system.

FIG. 3 is a schematic diagram showing an overall view of the image forming apparatus.

FIG. 4 is a schematic diagram of the sheet supplying device.

FIG. 5 details a section which prevents a sheet supplying tray from being drawn out.

FIG. 6 is a schematic diagram of the scanner.

FIG. 7 is a flow chart of sequences to prevent a sheet supplying tray from being drawn out.

### DETAILED DESCRIPTION OF THE PREFERRED EMBODIMENT

Embodiments relating to the present invention will now be detailed, while referring to the drawings.

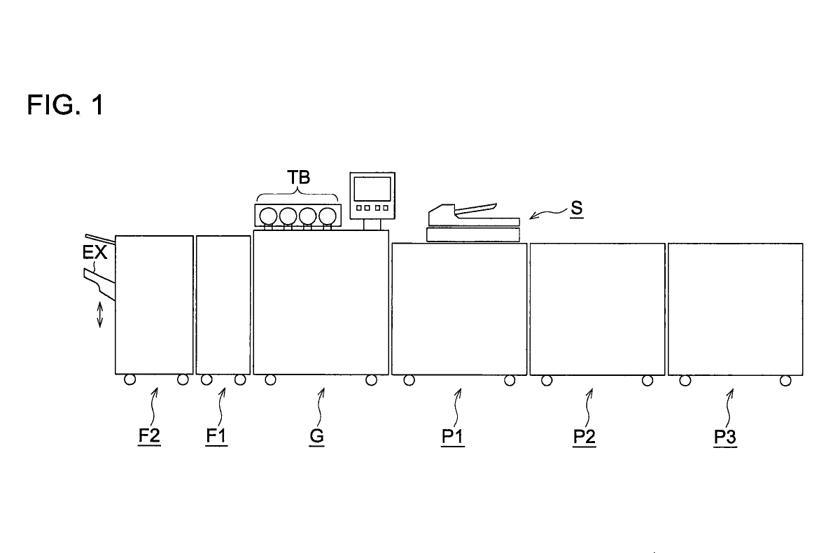

FIG. 1 is a schematic diagram of the image forming system.

The image forming system shown as an example is structured of image forming apparatus G, sheet supplying devices P1, P2 and P3, post finishing devices F1 and F2, and scanner S.

Image forming apparatus G is a high-speed color image forming apparatus, employing a well-known electronic photographic technology, on which toner cartridges TB, accommodating a great amount of toner particles, are mounted.

Connectable sheet supplying devices P1, P2 and P3 convey recording sheets to the image forming apparatus, and each includes the plurality of drawer-type sheet supplying trays, being able to be drawn out in the direction perpendicular to FIG. 1.

As the sheet supplying operation, an operator draws out one of the sheet supplying trays and stacks blank sheets on said sheet supplying tray, after which the operator pushes said sheet supplying tray to an original position.

Scanner S1, serving as a well-known original document reading device, is mounted on sheet supplying device P1.

Post finishing devices F1 and F2 conduct predetermined post finishing onto printed sheets outputted from image forming apparatus G. Post finishing device F1 of the present embodiment is referred to as a decurler which flattens any curled printed sheet conveyed from image forming apparatus G.

Further, post finishing device F2 is a book binding device including a hole-punching section and a binding section, and conducts a predetermined process onto the printed sheets conveyed from post finishing device F1, after which post finishing device F2 sequentially sends out a processed product to vertically movable ejecting tray EX.

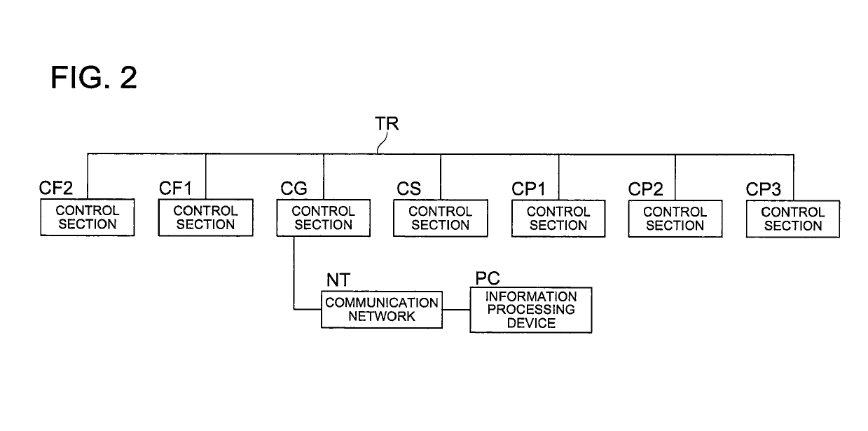

FIG. 2 is a block diagram to detail the image forming system of this invention.

Various devices, included in the image forming system, which are, image forming apparatus G, sheet supplying devices P1, P2 and P3, post finishing devices F1 and F2, and scanner S, have control section CG, control sections CP1, CP2 and CP3, control sections CF1 and CF2, and control section CS, respectively.

Each control section is a typical computer system, including a CPU, a memory section, an operating element, input-output interfaces of a communicating interface, and a driving circuit, in which the size of each control section is different. Various controls are conducted by predetermined programs, stored in the memory section of each control section.

Control section CG, control sections CP1, CP2 and CP3, control sections CF1 and CF2, and control section CS, are interconnected by communication section TR, so that information is sent to each other.

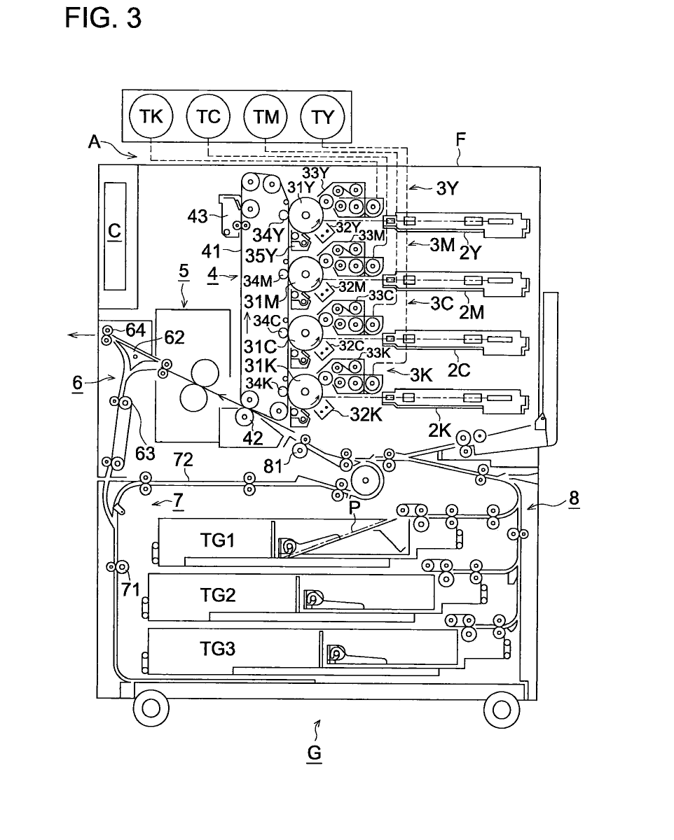

FIG. 3 is a schematic diagram showing an overall view of image forming apparatus G.

Image forming apparatus G is referred to as a tandem type color image forming apparatus, which forms a full-color printed image, and includes photosensitive bodies 31Y, 31M, 31C, and 31K, installed around a single intermediate transfer body 41.

Exampled image forming apparatus G is structured of exposure sections 2Y, 2M, 2C and 2K, image forming sections 3Y, 3M, 3C and 3K, intermediate transfer body 4, image fixing section 5, reversed sheet ejection section 6, sheet re-supplying section 7, sheet supplying section 8, and control section CG. Above these members, large-capacity toner cartridges TY, TM, TC, and TK, are installed.

In FIG. 2, information of images to be outputted is sent from information processing device PC connected through communication net work NT or scanner S, and tentatively stored in controls section CG, after which said information is processed by conditions previously determined by the operator, to become outputting image data.

In FIG. 3, exposure sections 2Y, 2M, 2C and 2K are structured of laser light sources, polygonal mirrors, and plural lenses, to generate laser beams, respectively.

Corresponding to an output signal outputted based on said outputting image data sent from control section C, exposure sections 2Y, 2M, 2C and 2K conduct the scanning exposures by laser beams on the surfaces of photosensitive bodies 31Y, 31M, 31C and 31K, which are structuring elements of image forming sections 3Y, 3M, 3C and 3K.

Due to the exposures conducted by laser beam scanning, latent images are formed on photosensitive bodies 31Y, 31M, 31C and 31K, respectively.

Main electrical charging section 32Y, developing section 33Y, first transfer rollers 34Y, and cleaning section 35Y are mounted around photosensitive body 31Y. Around photosensitive bodies 31M, 31C and 31K, similar devices for the respective colors are mounted. These structures are well-known technologies, employed in common electro-photographic color image forming apparatus.

The latent images formed on photosensitive bodies 31Y, 31M, 31C and 31K are developed by developing sections 33Y, 33M, 33C and 33K, so that a color toner image is created on each photo sensitive body.

Said color toner images, formed on photo sensitive bodies 31Y, 31M, 31C and 31K, are sequentially transferred onto predetermined positions of intermediate transfer belt 41, serving as an intermediate transfer body, by first transfer rollers 34Y, 34M, 34C and 34K of intermediate transfer section 4, respectively.

After each color toner image has been transferred, color toner particles, remaining on the surfaces of photo sensitive bodies 31Y, 31M, 31C and 31K, are cleaned by cleaning sections 35Y, 35M, 35C and 35K, respectively.

The toner images, transferred onto intermediate transfer belt 41, are transferred by second transfer roller 42, onto recording sheet P, serving as a transferred image carrying member, which is conveyed with appropriate timing, by sheet supplying roller 81, from sheet supplying section 8, having the plurality of sheet supplying trays TG1, TG2 and TG3.

After that, the surface of intermediate transfer belt 41 is cleaned by belt cleaning section 43, and is used for the subsequent transfer operation.

Recording sheet P, carrying the transferred toner image, is conveyed to image fixing section 5, whereby said toner image is permanently fixed onto recording sheet P by application of heat and pressure.

After that, recording sheet P, carrying the fixed image, is conveyed to post finishing device F1, through reversed sheet ejection section 6.

When reversed recording sheet P is ejected, recording sheet P is once guided downward by ejection guide 62, at which the end of recording sheet P is nipped by paired reversing ejection rollers 63, after which recording sheet P is directed toward paired ejection rollers 64 through ejection guide 62, by reversed rotation of paired reversing ejection rollers 63.

Further, when image formation is to be conducted on the reverse surface of recording sheet P, after the image formation on the front surface, the operation is conducted as described below. Recording sheet P, carrying the image fixed on the front surface, is conveyed downward to sheet re-supplying section 7 through ejection guide 62, whereby the end of recording sheet P is nipped by paired sheet re-supplying rollers 71, after which recording sheet P is conveyed in the opposite direction to be reversed, and recording sheet P is then conveyed into sheet re-supplying conveyance route 72, whereby an image is formed on the reverse surface of recording sheet P.

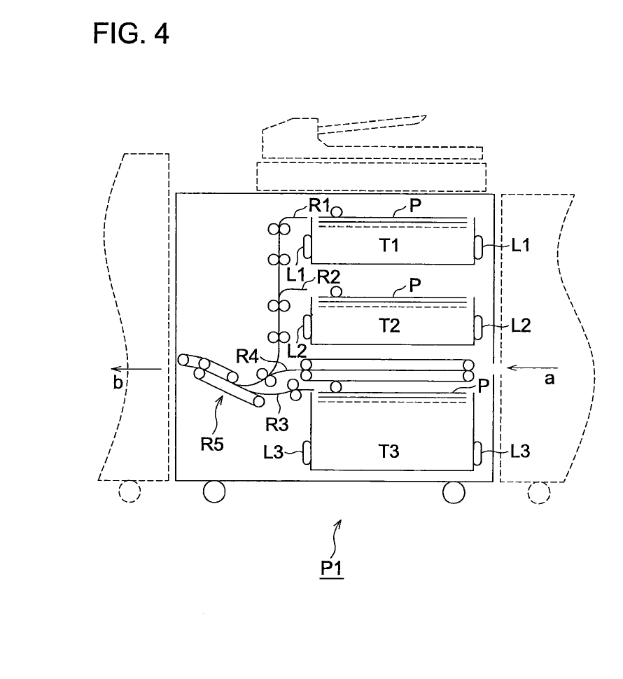

FIG. 4 is a schematic diagram of sheet supplying device P1.

Sheet supplying devices P1, P2 and P3 are formed to be a similar structure, and are configured to be connected to each other, so that the explanation will be concerned to only for sheet supplying device P1.

Sheet supplying device P1 includes sheet supplying trays T1, T2 and T3, formed as the three stages, on which recording sheets P are placed. Sheet supplying trays T1, T2 and T3 can be drawn out, moving on slide rails L1, L2 and L3, provided on both sides of each tray.

In addition, the sheet supplying device incorporating said plurality of sheet supplying trays is well-known, the number of stages and sheet capacity of each tray are determined when the sheet supplying device is designed.

Sheet supplying device P1 has sheet conveyance routes R1, R2, R3, R4 and R5, being the five routes, each of which includes guide members, conveyance belts, rollers, and the like.

Conveyance route R1 conveys recording sheet P1 which has been delivered from sheet supplying tray T1, to conveyance route R5, conveyance route R2 conveys recording sheet P1 which has been delivered from sheet supplying tray T2, to conveyance route R5, while conveyance route R3 conveys recording sheet P1, which has been delivered from sheet supplying tray T3, to conveyance route R5.

Conveyance route R4 conveys recording sheet P1 which has been conveyed in the direction of arrow “a” in FIG. 4, to conveyance route R5.

Conveyance route R5 conveys recording sheet P1 which has been conveyed from one of conveyance routes R1, R2, R3 and R4, in the direction of arrow “b” in FIG. 4, that is, in the present embodiment, conveyance route R5 conveys sheet P to image forming apparatus G.

As shown in FIG. 4, among three-stage sheet supplying trays T1, T2 and T3 of each sheet supplying device of the present embodiments, sheet supplying tray T3, being the lowest stage, is structured to accommodate more sheets P than sheet supplying trays T2 and T3, being the upper stages.

Tray T3 is structured to convey sheet P more linearly than those, delivered from sheet supplying trays T1 and T2.

The above structure in the present image forming system means that the usage of sheet supplying tray T3, being the lowest stage, results in a more effective operation rate as well as higher reliability.

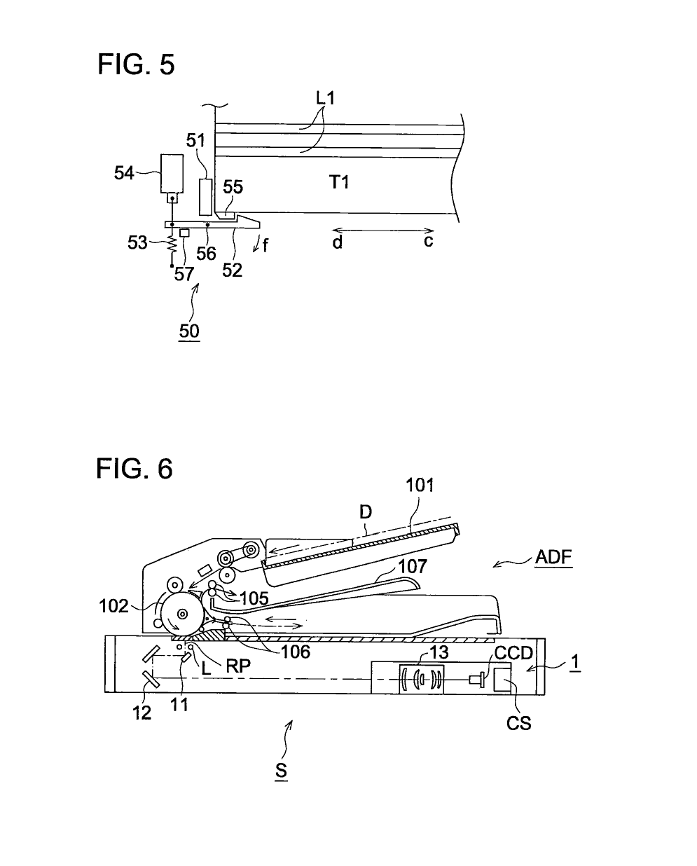

FIG. 5 details tray drawn-out preventing section 50.

As described above, sheet supplying trays T1, T2 and T3 are moved, being guided by slide rails L1, L2 and L3, which are provided on both sides of sheet supplying trays T1, T2 and T3.

Tray drawn-out preventing section 50 is structured to prevent each sheet supplying tray from being drawn out, or to allow each sheet supplying tray to be drawn out, whereby said tray drawn-out preventing section 50 is provided to correspond to each of the sheet supplying trays.

Since tray drawn-out preventing sections 50, provided for each sheet supplying tray, being T1, T2, and T3, are designed to be the same structure, only one sheet supplying tray T1 will be detailed for this explanation.

Sheets P are placed on a sheet supplying tray, such as T1, having been drawn out in the direction shown by arrow “c” of FIG. 5. Sheet supplying tray T1, on which sheets P have been placed, is driven in the direction of arrow “d”, after which sheet supplying tray T1 is stopped at a position which is regulated by stopper 51.

Tray drawn-out preventing section 50 is structured of lever 52, spring 53, solenoid 54, and the like.

Pivotable lever 52 rotates on supporting point 56, and is pulled by spring 53, until lever 52 is stopped by regulation member 57.

Lever 52 interlocks with plate 55 which has been mounted at the bottom of sheet supplying tray T1, whereby sheet supplying tray T1 is prevented from moving in direction “c” in FIG. 5.

When sheet supplying tray T1, which has been prevented from moving, is to be moved, solenoid 54 is actuated so that lever 52 rotates in direction “f” in FIG. 5, whereby the locked condition between lever 52 and plate 55 is released, allowing sheet supplying tray T1 to move.

Accordingly, the locking of sheet supplying tray T1 is conducted by de-actuation of solenoid 54.

FIG. 6 is a schematic diagram of scanner S.

Scanner S is structured of automatic document feeding device ADF, and document reading section 1.

Original document D, placed on original document plate 101 of automatic document feeding device ADF, is conveyed one by one toward the document route, and conveyed by conveyance drum 102.

While original document D is conveyed, an image carried on original document D is read out by document reading section 1 at document image reading position RP. After the image has been read, document D is eventually ejected onto document ejection plate 107 by first conveyance guide GI and paired document ejection rollers 105.

In order to read the image carried on the reverse surface of document D, document D is guided to paired reversing rollers 106 after the front surface of document D has been read. After that said paired reversing rollers 106 are controlled to rotate in an opposite direction, that is, the trailing edge of document D is turned to be the leading edge, and document D is again conveyed to conveyance drum 102.

After that, the reverse surface of document D is read by document reading section 1 at document image reading position RP in the same manner as the case of the front surface, after which document D is ejected onto document ejection plate 107.

Document reading section 1 allows lamp L to radiate light rays onto the image of document D at document image reading position RP, and concentrates reflected light rays onto a light acceptance surface of image capturing element CCD, through first mirror unit 11, second mirror unit 12, and lens 13.

Control section CS conducts various processes, such as A/D conversion, shading correction, image compression, and the like, on an image signal which has been photo-electrically converted by image capturing element CCD, after which control section CS stores the processed image signal in a memory section as an image data.

Said processed image data, temporarily stored in said memory section, is sent to control section CG of image forming apparatus G, through communication section TR.

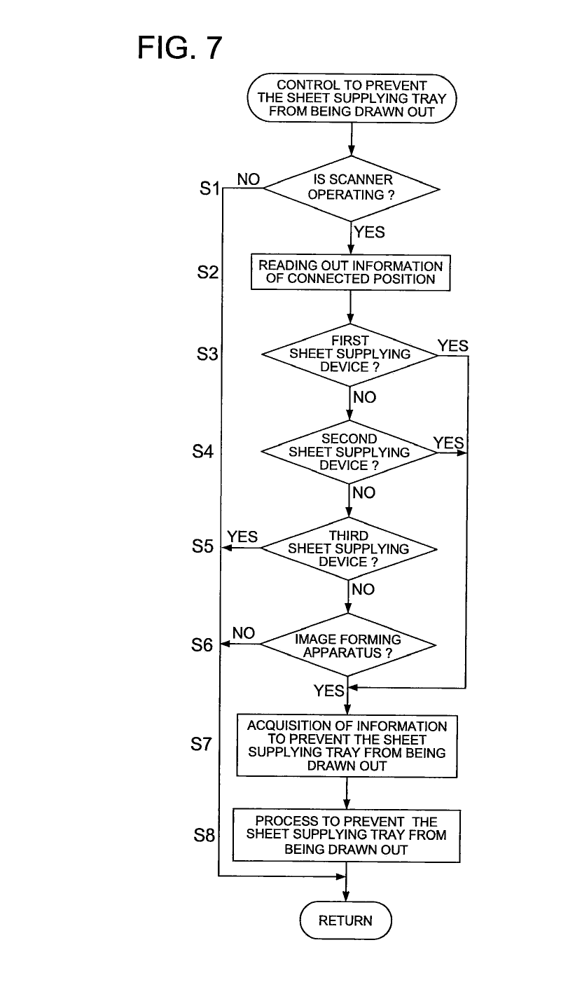

FIG. 7 is a flow chart of sequences to prevent a sheet supplying tray from being drawn out, in the image forming system of the present invention.

As preconditions of the explanation of the present embodiment, scanner S is mounted on first sheet supplying device P1, and each control section controls each device individually. However, said preconditions may be properly changed during the system design.

After the control section of image forming apparatus G, and the control sections of sheet supplying devices P1, P2 and P3, recognize the operation of scanner S (“yes” on step S1), all of the control sections read out information of connected position for themselves, from their memory sections (step S3).

Said information of the connected position represents positions where said apparatus and devices are connected. That is, when the system is structured, information of said apparatus and devices is automatically recognized and stored in their memory sections.

For example, in control section CG of image forming apparatus G, information is stored showing that image forming apparatus CG is connected between post finishing device F1 and sheet supplying device P1. In control section CP2 of sheet supplying device P2, information is stored showing that sheet supplying device P2 is connected between sheet supplying device P1 and sheet supplying device P3.

In case that, a control section recognized that said control section was included in first sheet supplying device P1 based on information of the connected position (“yes” on step S3), said control section reads out information of draw-out prevention, which has been previously stored in a predetermined table of the memory section of control section CP1, and said control section specifies which sheet supplying tray is to be prevented from being drawn out (step S7), that is, said control section controls draw-out prevention section 50 to prevent the specified tray from being drawn out (step S8).

In this case, said drawn-out prevented tray was specified by the control section, because said tray might adversely effect the reading operation conducted by scanner S, due to vibration generated while recording sheets P were replenished on said tray.

The adverse effect on the reading operation conducted by scanner S depends upon the position of sheet supplying tray, and on the amount of recording sheets S to be accommodated in the sheet supplying tray. Accordingly, said adverse effect is studied during the design work of the system, and is stored in control section CP1.

Further, after the amount of recording sheets P, in the sheet supplying tray, or being accommodated during the sheet supplying operation, is detected, the sheet supplying tray is prevented from being drawn out, based on the amount of recording sheets P, or further the sheet supplying tray is prevented from being returned until the operation of scanner S is stopped.

In case that, a control section recognized that said control section was included in second sheet supplying device P2, based on information of the connected position, (“yes” on step S4), said control section reads out information of draw-out prevention, which has been previously stored in a predetermined table of the memory section of control section CP2, and said control section specifies which sheet supplying tray is to be prevented from being drawn out (step S7), whereby said control section controls draw-out prevention section 50 so that the specified tray cannot be drawn out (step S8).

In case that, a control section recognized that said control section was included in third sheet supplying device P3, based on information of the connected positions, (“yes” on step S5), said control section CP3 controls the processing operation to go out of the routine work as shown in FIG. 7, without conducting any draw-out prevention process (“yes” on step S5).

More specifically, since second sheet supplying device P2 is positioned between third sheet supplying device P3 and first sheet supplying device P1 mounting scanner S, any vibration generated by the sheet supplying operation of third sheet supplying device P3, does not adversely effect the operation of scanner S. Accordingly, the sheet supplying operation conducted by third sheet supplying device P3, which is conducted while the sheet supplying tray is drawn out, is always allowed.

In case that, a control section recognized that said control section was included in image forming apparatus G, based on information of the connected position, (“yes” on step S6), said control section reads out information of draw-out prevention, which has previously been stored in a predetermined table of the memory section of control section CG, and said control section specifies which sheet supplying tray is to be prevented from being drawn out (step S7), whereby control section CG controls draw-out prevention section 50 so that the specified tray cannot be drawn out (step S8), and said control section CG controls the processing operation to go out of the routine work as shown in FIG. 7.

The above detailed operation for preventing the sheet supplying tray from being drawn out, concerns a case that a sheet supplying tray to be prevented from being drawn out is previously set, while scanner S operates.

In an actual image forming system, concerning both the vibration generated while sheet supplying tray TG3, located at the lower-most stage of image forming apparatus G, is drawn out or inserted, and the vibration generated while sheet supplying trays T3, located at lower most stages of sheet supplying devices P1, P2 and P3, are drawn out or inserted, these vibrations tend not to affect the reading operation conducted by scanner S.

Accordingly, it is possible in this case to control the system in such a way that the lower-most tray is always allowed to be drawn out or inserted, and the other trays are prevented from being drawn out or inserted, during the reading operation conducted by scanner S.

As detailed above, the image forming system of the present invention prevents recording sheet supplying operations which produce vibration to be transferred to scanner S, but allows any recording sheet supplying operation which does not transfer the adverse vibration to scanner S.

By these operations, the reading operation, to be conducted by the scanner to read the images carried on the recording sheets can preferably be conducted without failure, while reading quality of the image of the original document is successfully ensured.

Further, since not prevented is the sheet supplying operation onto any tray, to which the vibration generated during the sheet supplying operation is not transferred, the sheets can be supplied onto these trays as necessary.

Accordingly, prevented can be any adverse interruption of the image forming system, due to the stop of the replenishment of recording sheets, so that the image forming system can attain the higher productivity.

What is claimed is:

1. An image forming system, comprising:
an image forming apparatus; and
a first sheet supplying device which is connected to the image forming apparatus;
wherein the first sheet supplying device includes:
a scanner;
a plurality of drawer-type sheet supplying trays; and
a control section which is configured to prevent a predetermined sheet supplying tray among the plurality of sheet supplying trays from being drawn out, based on an operational condition of the scanner.

2. The image forming system of claim 1, further comprising:
a second sheet supplying device which is connected to the first sheet supplying device,
wherein the image forming apparatus and the second sheet supplying device each includes:
a plurality of drawer-type sheet supplying trays, and
a control section which is configured to prevent a predetermined sheet supplying tray among the plurality of drawer-type sheet supplying trays from being drawn out, based on an operational condition of the scanner.

3. The image forming system of claim 1, wherein the control section allows a lower-most sheet supplying tray among the plurality of drawer-type sheet supplying trays to be drawn out.

4. The image forming system of claim 2, wherein a drawer-type sheet supplying tray is specified not to be drawn out among the plurality of drawer-type sheet supplying trays, based on a sheet accommodating capacity of each sheet supplying tray.

5. The image forming system of claim 2, further comprising:
a third sheet supplying device which is connected to the second sheet supplying device,
wherein the third sheet supplying device includes:
a plurality of drawer-type sheet supplying trays: and
a control section which is configured to allow all of the sheet supplying trays to be drawn out, regardless of the operational condition of the scanner.
